(19) United States
(12) Patent Application Publication
(10) Pub. No.: US 2004/0036255 A1
(43) Pub. Date: Feb. 26, 2004

(54) Tow dolly with cargo carrying platform

(76) Inventor: Sam Stephen Orlando, Bloomfield Hills, MI (US)

Correspondence Address: Sam S. Orlando, 255 Alice Ave., Bloomfield Hills, MI, 48302, US

(21) Appl. No.: 10/224,665

(22) Filed: Aug. 22, 2002

(51) Int. Cl. B60P 3/06

(52) U.S. Cl. 280/402

(57) ABSTRACT

An extended tow dolly frame (24), a cargo platform frame (32), and cargo platform springs (30), assembled together to provide added cushioned cargo carrying space for various types of cargo (14).

### CROSS-REFERENCE TO RELATED APPLICATIONS

Not applicable.

### BACKGROUND—FIELD OF INVENTION

This invention relates to adding a cushioned cargo carrying platform to an automotive tow dolly.

### BACKGROUND—DESCRIPTION OF PRIOR ART

An automotive tow dolly is a trailer device that is attached with a hitch to the towing vehicle (ie. Truck or motor home) and carries the front wheels of the towed automobile while the rear wheels of the towed automobile are on the ground. The prior art of U.S. Pat. No. 5,342,162 to Larry Robinette, August 1994 is an example of a standard tow dolly. The problem with the standard automotive tow dolly is there is no room for carrying any added cargo other than the towed vehicle. Also, any cargo that could be carried would be un-cushioned due to the fact that tow dollies have no suspension and are dependent on the towed automobile for its front suspension to absorb bumps transmitted through the tow dolly frame. Jarring a load carried on the tow dolly between the dolly tongue and the dolly wheels with no cushioning would play havoc on cargo such as motorcycles, ATVs, golf carts, etc..

Another form of towing a vehicle is a tow bar. The tow bar is an apparatus that attaches the front of the towed vehicle to the trailer hitch of the towing vehicle. The prior art of U.S. Pat. No. 5,224,960 to Lee H. Duncan, July 1993 is an example of a tow bar. Un-like the tow dolly, a tow bar leaves all four tires of the towed vehicle on the ground. A major disadvantage of towing four tires on the ground is the vehicle must be manufactured or equipped with proper lubrication to the drive train while the engine is not running. Some vehicle manufactures require scheduled stops during travel for starting the towed vehicles engine up for a few minutes so as to re-lubricate the transmission.

The prior art of U.S. Pat. No. 5,501,481 to William M. Chumley, March 1996, and U.S. Pat. No. 5,609,350 to William M. Chumley, March 1997, expands upon the tow bar by adding a cargo area on top of the tow bar. This is awkward in that the load must be removed or the load must be stabilized with its retractable wheels prior to un-hitching the towed vehicle for use.

### SUMMARY

Accordingly, it is an important object of this invention to provide a cargo carrying platform on a tow dolly that is cushioned with springs for supporting cargo.

### OBJECTS AND ADVANTAGES

Several objects and advantages of the present invention are:

(a) To provide an extended tow dolly frame with added space to carry a platform for cargo.

(b) To provide a cargo platform that can haul many different types of cargo such as motorcycles, all terrain vehicles (ATVs), golf carts, and other miscellaneous cargo.

(c) To provide cushioning for the cargo carrying platform.

Further objects and advantages are to provide a better means of towing a vehicle with cargo over the use of the tow bar.

### DRAWING FIGURES

FIG. 1 shows the side view of the tow dolly with towing vehicle, vehicle in tow, and cargo carrying platform with cargo.

FIG. 2 shows the top view of the tow dolly with cargo carrying platform.

FIG. 3 shows the side view of the cargo platform only.

FIG. 4 shows the top view of the cargo platform only.

### REFERENCE NUMERALS IN DRAWINGS

10 towed vehicle

12 towing vehicle

14 sample cargo

16 trailer hitch

18 trailer jack

20 dolly wheel assembly

22 loading ramp

24 tow dolly frame

26 dolly tongue

30 cargo platform spring

32 cargo platform frame

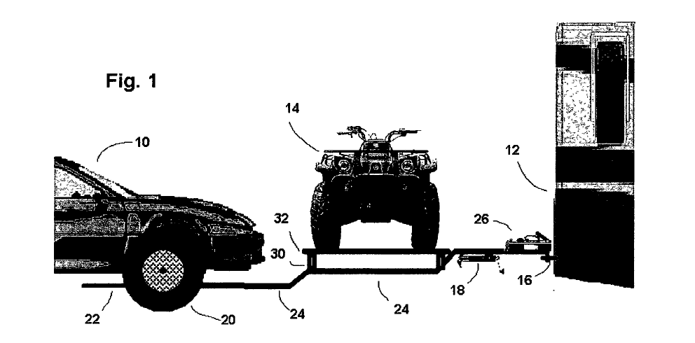

### DESCRIPTION—FIG. 1

A tow dolly with cargo carrying platform of the present invention is illustrated in FIG. 1 (side view). The tow dolly is shown with a towed vehicle 10, a towing vehicle 12, and a sample cargo 14. The towed vehicle 10 is any type of vehicle that is within the acceptable weight requirements of the tow dolly. The tow dolly main components are a loading ramp 22, a dolly wheel assembly 20, a trailer jack 18, and a dolly tongue 26. The towing vehicle 12 has a trailer hitch 16. The towing vehicle 12 is any type of vehicle with a conventional trailer hitch 16 with a rating that is within the acceptable weight classification required by the dolly manufacturer. A tow dolly frame 24 can be manufactured from any suitable material with sufficient strength and rigidity to support a cargo platform frame 32. The added frame length supports the cargo platform 32 with the cargo platform springs 30. The cargo platform frame 32 is manufactured from any suitable material such as steel or aluminum that will support cargo. The cargo platform springs 30 cushion the cargo during transportation.

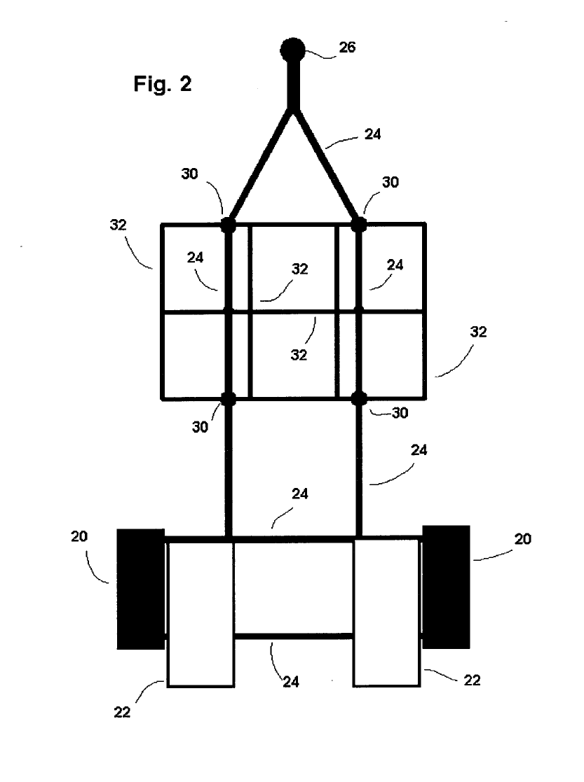

### DESCRIPTION—FIG. 2

The tow dolly with cargo carrying platform of the present invention is also illustrated in FIG. 2 (top view). The components shown are the tow dolly frame 24, the loading ramps 22, the dolly wheel assemblies 20, the dolly tongue 26, the cargo platform springs 30, and the cargo platform frame 32.

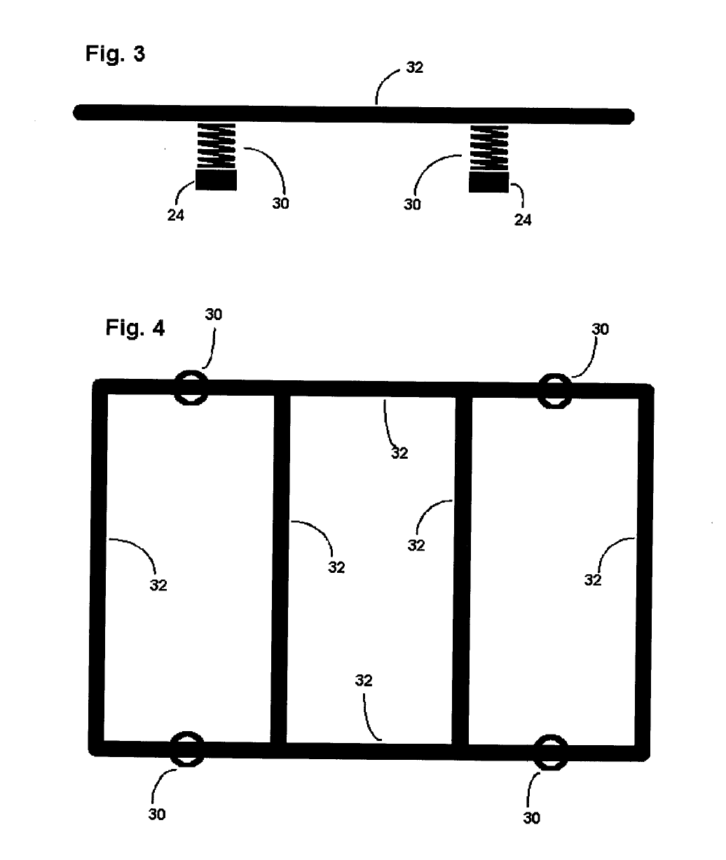

### DESCRIPTION—FIG. 3

The tow dolly cargo carrying platform of the present invention is also illustrated in FIG. 3 (front side view and same as back side view). This view shows the cargo platform springs 30 attached to the tow dolly frame 24 and supporting the cargo platform frame 32. Springs of conventional types are used. Conventional spring types that will support the load capacity are leaf, compression, torsion, extension, air, etc..

### DESCRIPTION—FIG. 4

The tow dolly cargo carrying platform of the present invention is also illustrated in FIG. 4 (top view). This shows the positioning of the cargo platform springs 30. It also shows a typical cargo platform frame 32 design, the main function of which is to support the cargo.

### OPERATION

The tow dolly is utilized in an identical fashion to that of other tow dollies with the added feature of hauling the cargo 14. The tow dolly has the loading ramp 22 for easy loading of the towed vehicle 10. The tow dolly is coupled to the towing vehicle 12 using the dolly tongue 26 and the trailer hitch 16. The trailer jack 18 is used to support and stabilize the load when not hitched to the towing vehicle 12. The cushioned cargo platform frame 32 attached to the extended tow dolly frame 24 provides the tow dolly with its cargo carrying ability. The cargo platform frame 32 is designed for various sizes and shapes of cargo. The platform spring 30 mounting methods are of any type that will attach the spring on one end to the cargo platform frame 32 and the other end to the tow dolly frame 24. Another method of mounting the platform spring 30 is between the dolly wheels and dolly frame. Mounting methods used are conventional welding, clamping, bolting, etc..

Different cargo carrying apparatuses may be added to the cargo platform frame 32 for loading and securing the cargo. One such apparatus may be rails to secure the tires of motorcycles, ATVs, golf carts, etc.. Another such apparatus may be a large box for storage of tools, camping equipment, or other miscellaneous items. Heavy gauge metal mesh screen, wood, or other equivalent materials may be attached to the cargo platform frame 32 as a cargo base for securing other types of cargo during transportation.

The maximum weight for the cargo 14 is dependent on the gross vehicle weight rating of both the tow dolly and the towing vehicle 12. Approximately 50 percent of the cargo weight is distributed on the dolly tongue 26 requiring a trailer hitch 16 with a rating exceeding the weight of the tow dolly tongue 26.

### CONCLUSION, RAMIFICATIONS, AND SCOPE

Thus the reader will see that the tow dolly with cargo carrying platform has some very unique advantages over the standard tow dolly. The operator now has the flexibility to carry additional cargo that could not have been carried before. The cargo is cushioned with suspension to allow movement for reaction to rough roads. The cargo platform may be manufactured from different materials and designed to carry cargo of different types.

I claim:

1. An automotive towing dolly having a platform positioned between the location where the towed vehicle's tires are secured, and the dolly hitch tongue at the front of the dolly, said platform's purpose being for hauling additional cargo.

2. The automotive towing dolly with said cargo carrying platform of claim 1, having said cargo carrying platform connected to said dolly with cushioning medium such as springs, for the purpose of cushioning said platform and cargo.

3. The automotive towing dolly with said cargo carrying platform of claim 1 having cushioning medium such as coil or leaf springs positioned between dolly wheels and dolly frame of said dolly for the purpose of cushioning both said cargo carrying platform and towed vehicle.
